(19) United States
(12) Patent Application Publication
(10) Pub. No.: US 2007/0046532 A1
(43) Pub. Date: Mar. 1, 2007

(54) Satellite positioning system aiding using a secondary satellite receiver

(75) Inventors: Brian E. Bucknor, Miramar, FL (US); Sergio Bustamante, Pembroke Pines, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/216,289

(22) Filed: Aug. 31, 2005

(51) Int. Cl. G01S 5/14

(52) U.S. Cl. 342/357.09; 342/357.15

(57) ABSTRACT

A method (400) and system (300) for determining an approximate location of a device (201) within the footprint of a SPS satellite (116) and a secondary satellite (114) can include a SPS receiver (104) for receiving positional assistance information from the SPS satellite, a secondary satellite receiver (102) for receiving positional assistance information such as ephemeris data from a secondary satellite, and a processor (310) for determining the approximate location based on the positional assistance information from the satellite position system satellite and the secondary satellite.

### FIELD OF THE INVENTION

This invention relates generally to Satellite Positioning System (SPS) devices, and more particularly to a method and system for using a secondary satellite receiver to aid in location determinations.

### BACKGROUND OF THE INVENTION

The Global Positioning System (GPS) has 24 satellites orbiting the earth (21 operational and 3 spares). These satellites are arranged into 6 high orbit planes at a height of 10,898 nautical miles or 20,200 kilometers with each orbit containing three or four satellites. The orbital planes form a 55 degree angle with the equator with orbital periods for each satellite of approximately 12 hours.

With no obstruction, there are typically 8-12 satellites visible at any one time from anywhere on earth. Each satellite contains a highly accurate (Rubidium atomic) clock. Taken together, several GPS satellites can represent an extremely accurate time standard available for synchronization at any point on the earth. It is this accurate timing that leads to an application of the GPS satellites separate from their function for navigation. The world's cellular and fiber communications use the time information derived from the GPS satellites for clock synchronization. Each satellite transmits a spread spectrum signal containing a BPSK (Bi-Phase Switched keyed) signal in which 1's and 0's are represented by reversal of the phase of the carrier. This message is transmitted at the L1 frequency 1575.42 MHz at a “chipping rate” of 50 bits per second. The message repeats every 30 minutes and is called the C/A signal (Coarse Acquisition signal). This message contains two important elements, the almanac and the ephemeris. The Almanac contains information about all the satellites in the constellation. This information is regularly updated from ground stations monitoring the system but almanac data remains useful for around one year. The Ephemeris contains short-lived information about the constellation and the particular satellite sending it. The particular satellite's information is updated from the GPS ground stations every four hours. Its validity in calculating position deteriorates gradually over this period as satellites rise and fall above the horizon. There are also other encrypted signals: the P code and Y code that are used for military applications transmitted at frequencies L1 & L2.

GPS signals are typically weak and require a radio frequency (RF) front end that has a low noise figure and very high gain. To derive a position solution including altitude, the GPS receiver must acquire and receive a full set of ephemeris from 4 or more satellites to compute a solution. The transfer of ephemeris from the GPS satellites is relatively slow (noted above as 50 bps), so alternative transmissions sources (such as a cell phone networks) have been used to send ephemeris and frequency uncertainty information to enable a GPS handset to compute a solution more expeditiously.

GPS is an example of a satellite position system (SPS) that may be utilized by a wireless device in combination with an appropriate GPS receiver to pinpoint the location of the wireless device on earth. The array of GPS satellites transmits highly accurate, time coded information that permits a receiver to calculate its exact location in terms of latitude and longitude on earth as well as the altitude above sea level (when 4 or more GPS satellites are acquired). The GPS system is designed to provide a base navigation system with accuracy to within 100 meters for non-military use and greater precision for the military.

As mentioned above, each of the orbiting satellites contains accurate clocks and more particularly four highly accurate atomic clocks. These provide precision timing pulses used to generate a unique binary code (also known as a pseudo random or pseudo noise “PN” code) that is transmitted to earth. The PN code identifies the specific satellite in the constellation. The satellite also transmits a set of digitally coded ephemeris data that completely defines the precise orbit of the satellite. The ephemeris data indicates where the satellite is at any given time, and its location may be specified in terms of a satellite ground track in precise latitude and longitude measurements. The information in the ephemeris data is coded and transmitted from the satellite providing an accurate indication of the exact position of the satellite above the earth at any given time. A ground control station updates the ephemeris data of the satellite once per day to ensure accuracy.

A GPS receiver configured in a wireless device is designed to pick up signals from three, four, or more satellites simultaneously. The GPS receiver decodes the information and, utilizing the time and ephemeris data, calculates the approximate position of the wireless device. The GPS receiver contains a floating-point processor that performs the necessary calculations and may output a decimal display of latitude and longitude as well as altitude on the handset. Readings from three satellites are necessary for latitude and longitude information. A fourth satellite reading is required in order to compute altitude.

Techniques that use cellular based location aiding information, however, still require a cellular network connection that may not necessarily be available within all of the areas within the footprint of the “viewable” GPS satellites. Thus, time to first fix (TTFF) times are usually relatively long.

Even with some additional information, TTFF times may be over thirty seconds because the ephemeris data must be acquired from the SPS system itself, and the SPS receiver typically needs a strong signal to acquire the ephemeris data reliably. These characteristics of a SPS system typically impact the reliability of position availability and power consumption in wireless devices. Typically, the accuracy of location-based solutions may vary from 150 meters to 300 meters in these types of environments. As a result, locating a wireless device in a 300 meter radius zone is unlikely unless there are other methods to help narrow the search.

Attempts at solving this problem have included utilizing pseudolites (such as base stations in a cellular telephone network) in combination with SPS, such as GPS, to determine the location of the wireless device.

### SUMMARY OF THE INVENTION

Embodiments in accordance with the present invention can utilize information received from a secondary satellite receiver to aid the GPS receiver in a similar manner as cellular phone networks and phone receivers have done. Any SPS capable device such as a GPS receiver (and not necessarily limited to a GPS enabled cell phone) can use information from a secondary satellite receiver such as a satellite digital audio radio receiver. Any SPS capable device such as a GPS device further equipped with another satellite receiver likely to receive higher power or bandwidth than the SPS devices are ideally suited for the embodiments herein.

In a first embodiment of the present invention, a method of determining an approximate location of a device within the footprint of a SPS satellite and a secondary satellite can include the steps of receiving positional assistance information from the SPS satellite (such as a GPS satellite), receiving positional assistance information (such as ephemeris data, precise timing, and frequency uncertainty data) from the secondary satellite (such as a satellite digital radio satellite), optionally receiving positional assistance information from a ground based communication system, and determining the approximate location based on the positional assistance information from the satellite position system satellite and the secondary satellite (and optionally from the positional assistance information from the ground based communication system). Note, the secondary satellite can be unassociated with the SPS satellite and have a higher transmission power or bandwidth than the SPS satellite. The method can optionally include the step of forwarding ephemeris data from a satellite position system ground station to a secondary satellite ground station and transmitting the ephemeris data to the secondary satellite via an uplink for the secondary satellite.

In a second embodiment of the present invention, a system for determining an approximate location of a device within the footprint of a SPS satellite and a secondary satellite can include a SPS receiver for receiving positional assistance information from a SPS satellite, a secondary satellite receiver for receiving positional assistance information such as ephemeris data, frequency, and time from a secondary satellite, and a processor for determining the approximate location based on the positional assistance information from the satellite position system satellite and the secondary satellite.

In a third embodiment of the present invention, a cellular phone can include a SPS receiver for receiving positional assistance information from a SPS satellite, a satellite digital radio receiver for receiving positional assistance information from a satellite radio satellite, and a processor for determining the approximate location based on the positional assistance information from the SPS satellite and the satellite radio satellite. Of course, the cellular phone can further include a cellular transceiver coupled to the SPS receiver. The SPS receiver can be a Global Positioning receiver and the satellite digital radio receiver can be among a satellite digital audio radio receiver and a satellite digital television receiver as examples.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a positioning system using a SPS receiver and a secondary satellite receiver in accordance with an embodiment of the present invention.

FIG. 2 is a block diagram of a positioning system using a SPS receiver, a secondary satellite receiver and an optional radio transceiver in accordance with an embodiment of the present invention.

FIG. 3 is a block diagram of a positioning system using a SPS receiver, a secondary satellite receiver and an optional radio transceiver in accordance with another embodiment of the present invention.

FIG. 4 is a flow chart illustrating a method of determining an approximate location of a device within the footprint of a SPS satellite and a secondary satellite in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

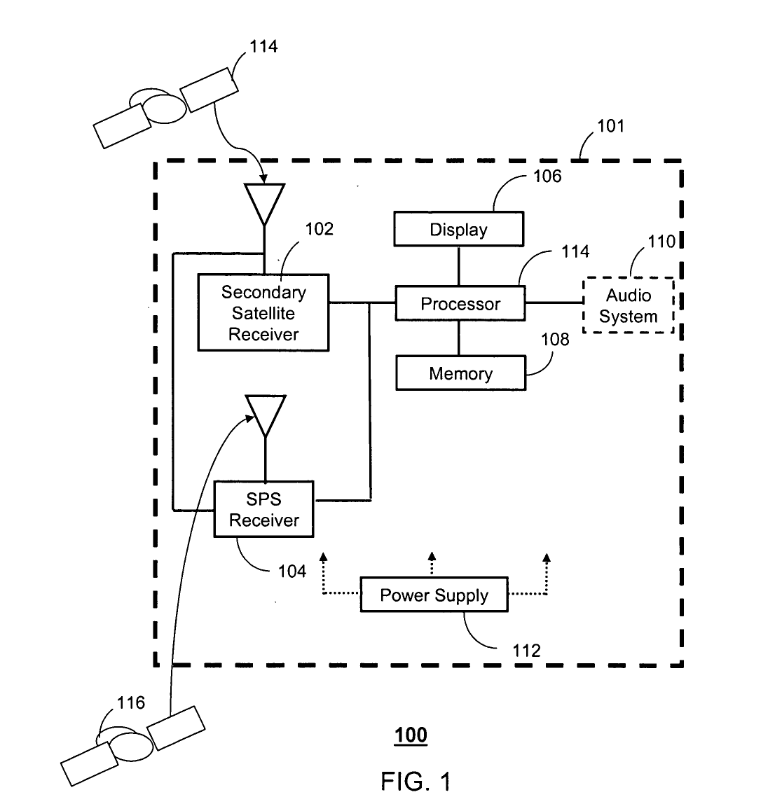

The aiding that can be received from a cell phone requires that the user be registered to a network and can load network traffic. If the user is not on a network, the GPS receiver reverts to a very slow autonomous mode. Fortunately, in a system 100 as illustrated in FIG. 1, a cellular phone and its network is optional. Instead, the system 100 can use a secondary satellite 114 and a secondary satellite receiver 102 (such as an XM Satellite Radio or a Sirius Satellite Radio) to assist with positional assistance information to enable an SPS receiver 104 to make a quicker approximate location determination. Since the secondary satellite signals are stronger than signals from an SPS satellite 116, the system 100 will acquire the secondary satellite 114 much faster than the SPS or GPS receiver 104 will acquire its satellites (116). The signal strengths of a typical satellite radio can be as much as 30 dBm higher than GPS, thus acquisition is faster. Bandwidth on the secondary satellite system is likely to be greater as well. The secondary satellite receiver can provide positional assistance information such as frequency uncertainty, precise time, and possibly pass GPS ephemeris periodically to the secondary satellite receiver 102. Optionally, the satellite radio system could upload GPS ephemeris to its satellites (114) which in turn can stream it back down to its receivers (102). At this point, a dual satellite receiver as illustrated can benefit from this ephemeris sooner than if ephemeris were provided from the SPS satellite alone. This method can provide the same level of GPS performance to users on and off a cellular phone network since the cellular network is not necessarily relied upon for location assistance.

Note, the secondary satellite receiver 102 and the SPS receiver 104 can be part of a device 101 such as a lap top computer or a cellular phone or any other electronic device. The electronic device can further include a display 106 for conveying images to a user of the device, a memory 108 including one or more storage elements (e.g., Static Random Access Memory, Dynamic RAM, Read Only Memory, etc.), an optional audio system 110 for conveying audible signals (e.g., voice messages, music, etc.) to the user of the device, a conventional power supply 112 for powering the components of the device, and a processor 114 comprising one or more conventional microprocessors and/or digital signal processors (DSPs) for controlling operations of the foregoing components.

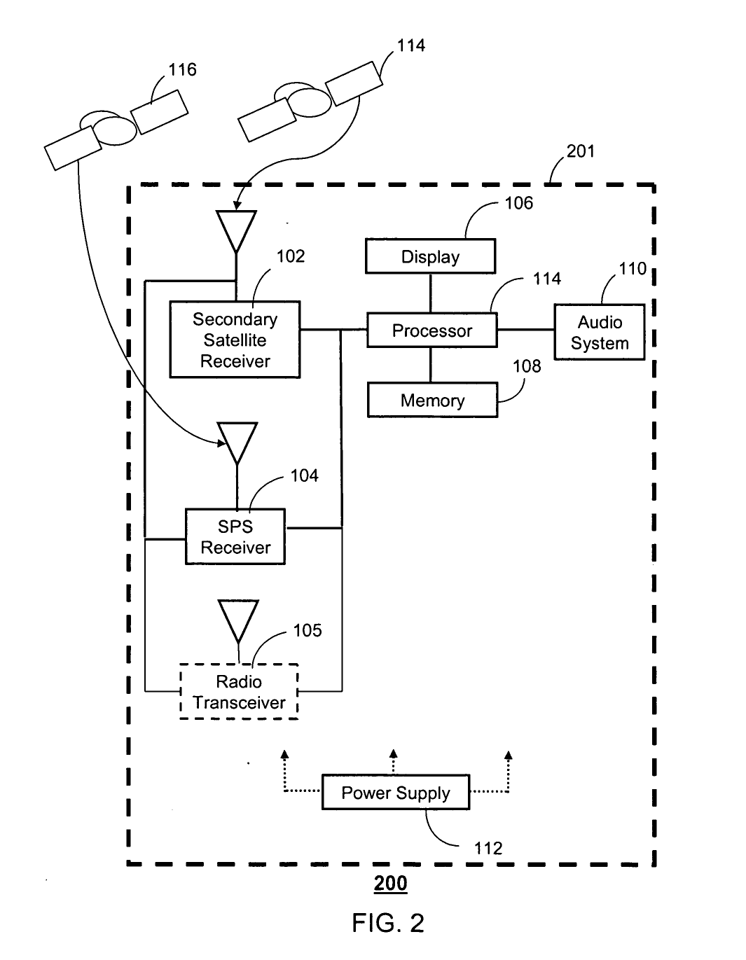

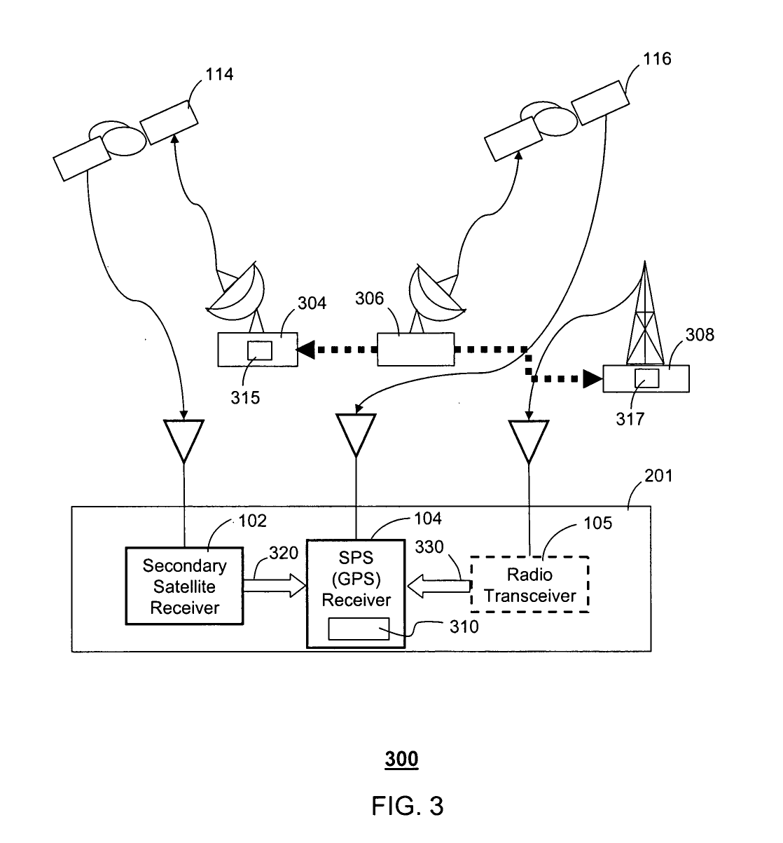

Referring to FIG. 2, a system 200 similar to system 100 can further include a wireless communication device 201 having the same components as device 101, but further including a radio transceiver 105 such as a cellular radio transceiver. In yet another system similar to system 200, a system 300 as shown in FIG. 3 further includes a ground based communication system 308 that can be in communication with the radio transceiver 105. The system 308 and radio transceiver 105 can be part of a cellular system. The system 300 can further include a SPS ground control station and uplink 306 and a secondary satellite ground control and uplink 304. Optionally, the satellite radio system or secondary satellite ground control 304 can obtain positional assistance information (such as ephemeris) from the SPS ground control station 306 and store or process such information in a memory or database 315 before uploading positional assistance information to its satellites (114) which in turn can stream it back down to its receivers (102). In yet another alternative, the ground based communication system 308 can obtain positional assistance information (such as ephemeris) from the SPS ground control station 306 and store or process such information in a memory or database 317 before transmitting such positional assistance information to its radio transceivers (105). The SPS receiver 104 can include a processor 310 that can process the positional assistance information 320 from the secondary satellite receiver 102 and optionally process the positional assistance information 330 from the (ground based) radio transceiver 105. Note, although the processor 310 is shown within the SPS receiver 104, embodiments are not necessarily limited to such arrangement.

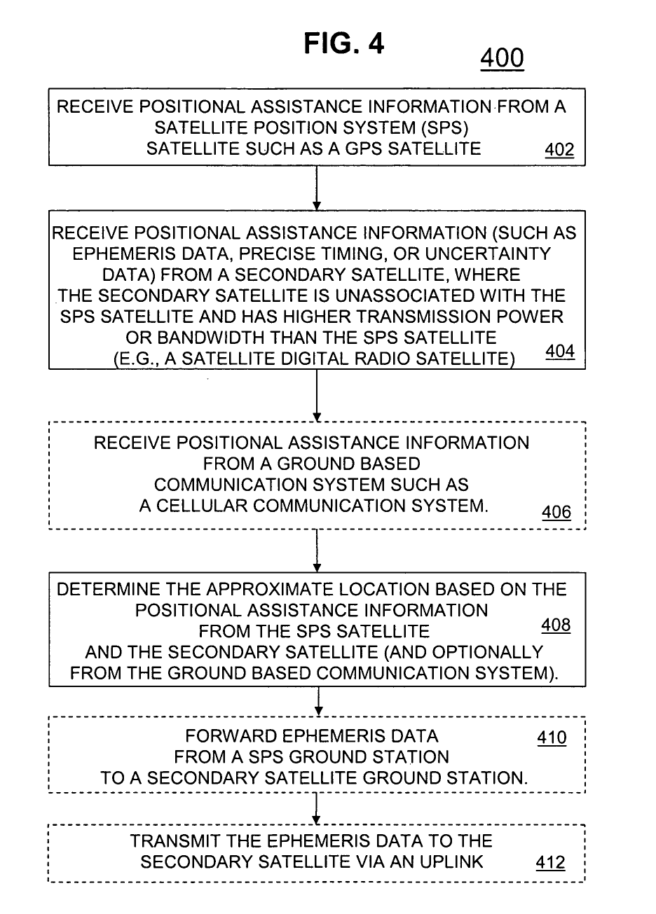

Operationally, the system 300 can operate in accordance a method 400 illustrated in the flow chart of FIG. 4. The method 400 can determine an approximate location of a device within the footprint of a SPS satellite and a secondary satellite. The method 400 can include the step 402 of receiving positional assistance information from the SPS satellite (such as a GPS satellite), receiving positional assistance information (such as ephemeris data, precise timing, and frequency uncertainty data) from the secondary satellite (such as a satellite digital radio satellite) at step 404, optionally receiving positional assistance information at step 406 from a ground based communication system, and determining the approximate location based on the positional assistance information from the satellite position system satellite and the secondary satellite (and optionally from the positional assistance information from the ground based communication system) at step 408. Note, the secondary satellite can be unassociated with the SPS satellite and have a higher transmission power or bandwidth than the SPS satellite. The method can optionally include the step 410 of forwarding ephemeris data from a satellite position system ground station to a secondary satellite ground station and transmitting at step 412 the ephemeris data to the secondary satellite via an uplink for the secondary satellite.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of determining an approximate location of a device within the footprint of a satellite position system satellite and a secondary satellite, comprising the steps of:
receiving positional assistance information from the satellite position system satellite;
receiving positional assistance information including ephemeris data from the secondary satellite, wherein the secondary satellite is unassociated with the satellite position system satellite; and
determining the approximate location based on the positional assistance information from the satellite position system satellite and the secondary satellite.

2. The method of claim 1, wherein the step of receiving positional assistance information from the secondary satellite comprises receiving positional assistance information from a secondary satellite having higher transmission power or bandwidth than the satellite position system satellite.

3. The method of claim 1, wherein the step of receiving positional assistance information from the secondary satellite comprises receiving positional assistance information from a satellite digital radio satellite.

4. The method of claim 1, wherein the method further comprises the step of forwarding ephemeris data from a satellite position system ground station to a secondary satellite ground station.

5. The method of claim 4, wherein the method further comprises transmitting the ephemeris data to the secondary satellite via an uplink for the secondary satellite.

6. The method of claim 1, wherein the method further comprises the step of receiving positional assistance information from ground based communication system.

7. The method of claim 6, wherein the method further comprises the step of determining the approximate location based on the positional assistance information from the satellite position system satellite, the secondary satellite, and the ground based communication system.

8. The method of claim 1, wherein the step of receiving positional assistance information comprises receiving among frequency uncertainty information, precise time information, and GPS ephemeris information.

9. A system for determining an approximate location of a device within the footprint of a satellite position system satellite and a secondary satellite, comprising:
a satellite position system receiver for receiving positional assistance information from a satellite position system satellite;
a secondary satellite receiver for receiving positional assistance information including ephemeris data from a secondary satellite, wherein the secondary satellite is unassociated with the satellite position system satellite; and
a processor for determining the approximate location based on the positional assistance information from the satellite position system satellite and the secondary satellite.

10. The system of claim 9, wherein the secondary satellite has higher transmission power or bandwidth than the satellite position system satellite.

11. The system of claim 9, wherein the secondary satellite comprises a satellite digital audio radio.

12. The system of claim 9, wherein the system further comprises a satellite position system ground station that forwards ephemeris data to a secondary satellite ground station.

13. The system of claim 12, wherein the system further comprises an uplink for the secondary satellite for transmitting the ephemeris data to the secondary satellite.

14. The system of claim 9, wherein the system further comprises a ground based communication system receiver for receiving positional assistance information from a ground based communication system.

15. The system of claim 9, wherein the processor is further programmed to determine the approximate location based on the positional assistance information from the satellite position system satellite, the secondary satellite, and the ground based communication system.

16. The system of claim 9, wherein the positional assistance information comprises among frequency uncertainty information, precise time information, and GPS ephemeris information.

17. The system of claim 14, wherein the satellite position system receiver, the secondary satellite receiver, and the ground based communication system receiver are a global positioning receiver, a satellite digital radio receiver, and a cellular radio receiver respectively.

18. A cellular phone, comprising:
a satellite position system receiver for receiving positional assistance information from a satellite position system satellite;
a satellite digital radio receiver for receiving positional assistance information from a satellite radio satellite; and
a processor for determining the approximate location based on the positional assistance information from the satellite position system satellite and the satellite radio satellite.

19. The cellular phone of claim 18, wherein the cellular phone further comprises a cellular transceiver coupled to the satellite position system receiver.

20. The cellular phone of claim 18, wherein the satellite position system receiver is a Global Positioning Receiver and the satellite digital radio receiver is among a satellite digital audio radio receiver and a satellite digital television receiver
